(19) United States
(12) Patent Application Publication
(10) Pub. No.: US 2024/0330780 A1
(43) Pub. Date: Oct. 3, 2024

(54) METHOD AND SYSTEM TO CLASSIFY NEWS SNIPPETS INTO CATEGORIES USING AN ENSEMBLE OF MACHINE LEARNING MODELS

(71) Applicant: Tata Consultancy Services Limited, Mumbai (IN)

(72) Inventors: NITIN VIJAYKUMAR RAMRAKHIYANI, Pune (IN); SANGAMESHWAR SURYAKANT PATIL, Pune (IN); GIRISH KESHAV PALSHIKAR, Pune (IN); ALOK KUMAR, Pune (IN)

(73) Assignee: Tata Consultancy Services Limited, Mumbai (IN)

(21) Appl. No.: 18/401,030

(22) Filed: Dec. 29, 2023

(30) Foreign Application Priority Data
Mar. 30, 2023 (IN) 202321024014

(51) Int. Cl. G06N 20/20

(52) U.S. Cl. CPC G06N 20/20

(57) ABSTRACT

This disclosure relates generally to method and system to classify news snippets into categories using an ensemble of machine learning models. The ensemble is between a bidirectional long short memory (BILSTM) based text classification network and a pretrained language model (PLM) based natural language inference (NLI) which is robust and accurate for such categorization. The method trains a first machine learning model using a training dataset to learn text representations. Further, the training dataset is used to finetune a second machine learning model to classify at least one unlabeled news snippet of unknown category based on a premise-hypothesis pair. Further, an ensemble of machine learning models is generated by using the first machine learning model and the second machine learning model to classify a set of test news snippets received as input request to corresponding category.

### PRIORITY CLAIM

This U.S. patent application claims priority under 35 U.S.C. § 119 to: Indian Patent Application 202321024014, filed on Mar. 30, 2023. The entire contents of the aforementioned application are incorporated herein by reference.

### TECHNICAL FIELD

The disclosure herein generally relates to text categorization, and, more particularly, to method and system to classify news snippets into categories using an ensemble of machine learning models.

### BACKGROUND

As digitization has advanced, the function of knowledge sources has changed significantly. Text mining has become more important as consumers now have access to data from a variety of sources, including electronic and digital media. There are many techniques for transforming text data from an unstructured state into an organized structure. When it comes to digital media information, news is one of the types that is conveniently available from content providers such as online news services. Texts in various fields contain large amounts of information that can be analyzed and used in many ways. News articles have a great impact on personal and social activities but selecting the right part of a news article is a difficult task for users from a large amount of sources. It is a very difficult area of text mining as it involves transformation of relevant data into structured information.

Industrial organizations have looked to information resource centers to use up-to-date corporate libraries to separate business-related materials from other non-business data in the daily news stream. Another strategy is to categorize business-related information in a user-friendly way. Several people are employed in the corporate library to collect business-related news, receive a series of business news articles and excerpts, read many of them daily, and collate those deemed relevant.

After the relevant news articles have been collected, these articles must be sorted and arranged in chronological order. Ultimately, organized information must be delivered to various consumers within the company, such as company executives, department heads, and sales teams. Reading a large number of snippets, relevance filtering, and manual categorization are just some of the tedious and time-consuming operations in the aforementioned pipeline. Library teams, with limited resources at their disposal, need automated support to scale the massive amounts of data accessed daily from news streams from many sources. Traditional classification techniques are not sufficient because these techniques do not group news articles based on major events. This is labor intensive and ineffective in organizing and disseminating news.

### SUMMARY

Embodiments of the present disclosure present technological improvements as solutions to one or more of the above-mentioned technical problems recognized by the inventors in conventional systems. For example, in one embodiment, a method for classifying news snippets into categories using an ensemble of machine learning models is provided. The method includes training a first machine learning model from a set of machine learning models using a training dataset to learn text representations and classify the learned representations into corresponding category from a set of categories. The training dataset is used to finetune a second machine learning model to classify at least one unlabeled news snippet of unknown category based on a premise-hypothesis pair, causing the second trained machine learning model to be agnostic to the first trained machine learning model. Further, an ensemble of machine learning models is generated by using the first machine learning model and the second machine learning model to classify a set of test news snippets received as input request to corresponding category.

In another aspect, a system to classify news snippets into categories using an ensemble of machine learning models is provided. The system includes training a first machine learning model from a set of machine learning models using a training dataset to learn text representations and classify the learned representations into corresponding category from a set of categories. The training dataset is used to finetune a second machine learning model to classify at least one unlabeled news snippet of unknown category based on a premise-hypothesis pair, causing the second trained machine learning model to be agnostic to the first trained machine learning model. Further, an ensemble of machine learning models is generated by using the first machine learning model and the second machine learning model to classify a set of test news snippets received as input request to corresponding category.

In yet another aspect, a non-transitory computer readable medium provides one or more non-transitory machine-readable information storage mediums comprising one or more instructions, which when executed by one or more hardware processors perform actions includes an I/O interface and a memory coupled to the processor is capable of executing programmed instructions stored in the processor in the memory to includes training a first machine learning model from a set of machine learning models using a training dataset to learn text representations and classify the learned representations into corresponding category from a set of categories. The training dataset is used to finetune a second machine learning model to classify at least one unlabeled news snippet of unknown category based on a premise-hypothesis pair, causing the second trained machine learning model to be agnostic to the first trained machine learning model. Further, an ensemble of machine learning models is generated by using the first machine learning model and the second machine learning model to classify a set of test news snippets received as input request to corresponding category.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 illustrates an exemplary system to classify news snippets using an ensemble of machine learning models, in accordance with some embodiments of the present disclosure.

FIG. 2 is a functional block diagram illustrating exemplary ensemble of machine learning models suitably trained to categorize news snippets using the system of FIG. 1, in accordance with some embodiments of the present disclosure.

FIG. 3 is an exemplary flow diagram of a processor-implemented method to classify news snippets using the system of FIG. 1, in accordance with some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments.

Enterprise information resource centers (IRC) aggregates business information from vast volumes of business news that are being manually processed. Business news are generated at a fast pace every day, creating overwhelming demands on consumers, organizations, and their executives. Categorizing business news according to key event types is an important step in reducing the burden of consumption. Executives who are solely interested in mergers and acquisitions will no longer have to search through every snippet. Business news snippets come in a variety of forms, including news on corporate events, research or analyst research, quarterly results, market research, and so forth. Targeted business news snippets usually highlight one or a few significant events and offer extra details about those occurrences. To determine the primary event kinds from news snippets and link these event types to relevant categories is the problem addressed in the present disclosure. The amount of manual work required to organize and distribute news is significantly reduced when these news snippets are automatically categorized based on significant events.

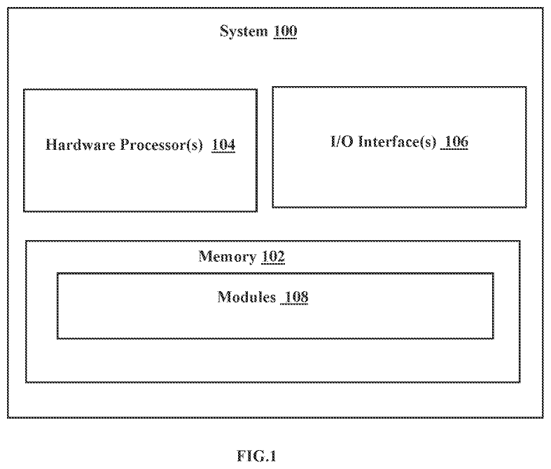

Embodiments herein provide a method and system to classify news snippets into categories using an ensemble of machine learning models. The disclosed method enables categorization of incoming news snippets into corresponding categories from a set of categories. The ensemble is between a bidirectional long short term memory (BILSTM)-based text classification network and a pretrained language model (PLM) based natural language inference (NLI) which is robust and accurate for such categorization. Additionally, fine-tuning of NLI and PLM improves the ensemble model performance. The method of the present disclosure is evaluated using two datasets. The disclosed system is further explained with the method as described in conjunction with FIG. 1 to FIG. 3 below.

Referring now to the drawings, and more particularly to FIG. 1 through FIG. 3, where similar reference characters denote corresponding features consistently throughout the figures, there are shown preferred embodiments, and these embodiments are described in the context of the following exemplary system and/or method.

FIG. 1 illustrates an exemplary system to classify news snippets using an ensemble of machine learning models, in accordance with some embodiments of the present disclosure. In an embodiment, the system 100 includes processor (s) 104, communication interface (s), alternatively referred as or input/output (I/O) interface(s) 106, and one or more data storage devices or memory 102 operatively coupled to the processor (s) 104. The system 100, with the processor(s) is configured to execute functions of one or more functional blocks of the system 100.

Referring to the components of the system 100, in an embodiment, the processor (s) 104 can be one or more hardware processors 104. In an embodiment, the one or more hardware processors 104 can be implemented as one or more microprocessors, microcomputers, microcontrollers, digital signal processors, central processing units, state machines, logic circuitries, and/or any devices that manipulate signals based on operational instructions. Among other capabilities, the processor(s) 104 is configured to fetch and execute computer-readable instructions stored in the memory. In an embodiment, the system 100 can be implemented in a variety of computing systems, such as laptop computers, notebooks, hand-held devices, workstations, mainframe computers, servers, a network cloud, and the like.

The I/O interface(s) 106 can include a variety of software and hardware interfaces, for example, a web interface, a graphical user interface, and the like and can facilitate multiple communications within a wide variety of networks and protocol types, including wired networks, for example, LAN, cable, etc., and wireless networks, such as WLAN, cellular, or satellite. In an embodiment, the I/O interface (s) 106 can include one or more ports for connecting a number of devices (nodes) of the system 100 to one another or to another server.

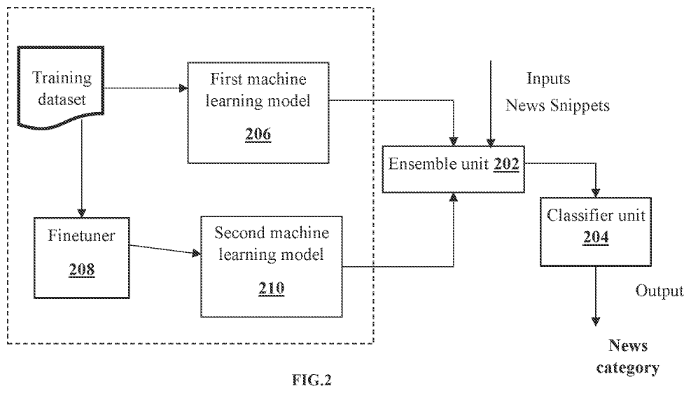

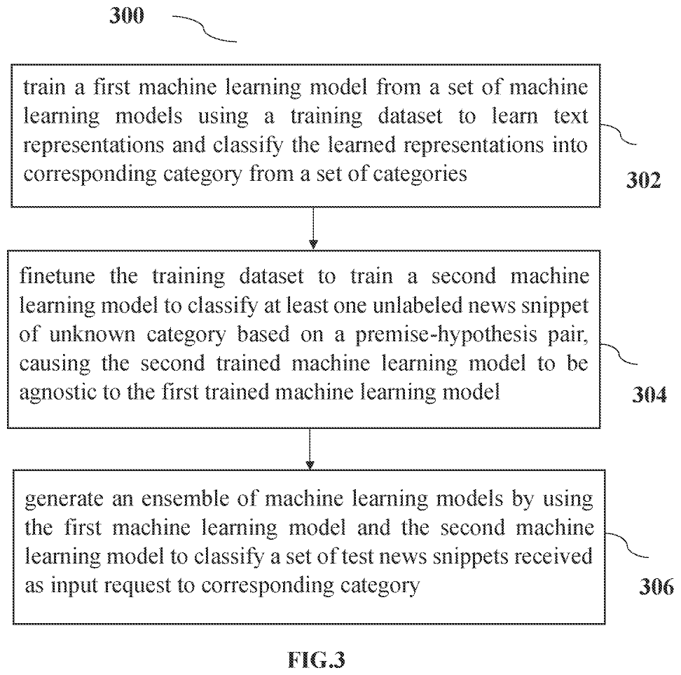

The memory 102 may include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes. The memory 102 may comprise information pertaining to input(s)/output(s) of each step performed by the processor(s) 104 of the system 100 and methods of the present disclosure. Functions of the components of system 100, to estimate smoking episodes are explained in conjunction with FIG. 2 and FIG. 3 providing flow diagram, architectural overviews, and performance analysis of the system 100.

FIG. 2 is a functional block diagram illustrating exemplary ensemble of machine learning models suitably trained to categorize news snippets using the system of FIG. 1, in accordance with some embodiments of the present disclosure. The system 100 includes an ensemble unit 202, a classifier unit 204, a first machine learning model 206, a fine tuner 208 and a second machine learning model 210.

The ensemble unit 202 is a set of trained machine learning models which processes an input comprising a set of test news snippets to be classified into corresponding category from a set of categories obtained from various engines.

The ensemble unit 202 of the system 100 fetches input from the first machine learning model 206, and the second machine learning model 210. The first machine learning model 206 may be for example a bidirectional long short memory (BILSTM). The second machine learning model 210 may be for example a pre-trained language model (PLM) based zero-shot natural language inference (NLI). The ensemble unit 202 of the system 100 may receive input from an online digital content, one or more news publishing engines, a datastore and thereof. There are different types of test news snippets. News focused on business events, research or analyst surveys, quarterly results, industry updates, legal or regulatory updates, etc. In each of them an important topic or type of event is reported and optionally other information around it.

The classifier unit 204 of the system 100 outputs the set of test news snippets into corresponding category from the set of categories for example sports, business, entertainment, politics and thereof.

FIG. 3 is an exemplary flow diagram of a processor-implemented method to classify news snippets using the system 100 of FIG. 1, in accordance with some embodiments of the present disclosure. In an embodiment, the system 100 comprises one or more data storage devices or the memory 102 operatively coupled to the processor(s) 104 and is configured to store instructions for execution of steps of the method 300 by the processor(s) or one or more hardware processors 104. The steps of the method 300 of the present disclosure will now be explained with reference to the components or blocks of the system 100 as depicted in FIG. 1 through FIG. 2 and the steps of flow diagram as depicted in FIG. 3. Although process steps, method steps, techniques or the like may be described in a sequential order, such processes, methods, and techniques may be configured to work in alternate orders. In other words, any sequence or order of steps that may be described does not necessarily indicate a requirement that the steps to be performed in that order. The steps of processes described herein may be performed in any order practical. Further, some steps may be performed simultaneously.

Referring now to the steps of the method 300, at step 302, the one or more hardware processors 104 train a first machine learning model from a set of machine learning models using a training dataset to learn text representations and classify the learned representations into corresponding category from a set of categories. The training dataset comprises a set of training news snippets, each training news snippet corresponding (or maps) to at least one category from the set of categories. For example, the training dataset may be mergers and acquisitions, customers and partners, product launches, financial reporting, research, and development; business expansion, human resources, branding, and corporate social responsibility. Right, Awards and Achievements, Analyst Reports and Research. Table 1 shows example training dataset which includes the training news snippet representing key events of “acquisitions”, and the category is “Mergers and Acquisitions”. Also, each training news snippet can have multiple primary events and multiple primary event types, as shown in Table 1.

TABLE 1
Example Training dataset (news snippets
with corresponding category)

| News Snippet | Category |
|---|---|
| European Aeronautic Defense and Space Co. | Mergers and |
| NV, the parent of aircraft maker Airbus, on | Acquisitions |
| Wednesday said it has agreed to acquire Racal | |
| Instruments Group for up to $130 million. | |
| Google Inc. won a major legal victory yesterday | Legal |
| when a federal judge ruled that the search | |
| engine's advertising policy does not violate | |
| federal trademark laws. | |
| NEW YORK (Reuters) - AT&T Inc. on Tuesday | Financial |
| posted higher-than-expected quarterly profit on | Reporting |
| strong wireless subscriber growth but results of | |
| the first two days of iPhone sales fell short of | |
| forecasts. | |
| LONDON (Reuters) - Shares in EMI Group Plc | Financial |
| (EMI.L) gained as much as 7.1 percent on | Reporting |
| Wednesday. Following a report that Warner | Mergers & |
| Music Group Corp. (WMG.N) was preparing a | Acquisitions |
| new bid to buy the world's third largest music | |
| company. | |
| Organization A has acquired Organization B, a | Mergers and |
| leader in developing and operating Product A | Acquisitions |
| cloud-based ecommerce sites, with a proprietary | |
| order management system (OMS) for the | |
| apparel and retail industries. | |
| Organization C wins Product B Partner | Awards and |
| Innovation Award for intelligent automation. | Achievements |
| Organization C has been awarded the 20xx | |
| Client Innovation Award by Organization D for its | |
| strong innovation and delivery capabilities. | |
| Organization E cuts annual forecast as revenue | Financial |
| growth hits record low. Organization E Inc. on | Reporting |
| Monday, cut its annual profit and revenue | |
| forecasts as demand for the video - conferencing | |
| platform cools off from pandemic highs amid stiff | |
| competition from Product C and Product D. | |
| Organization F and Organization G foundation | Customers & |
| announce new partnership with the Government | Partners, Human |
| of Country A to expand maternal health | Resources & |
| emergency transportation system. Today at the | CSR |
| U.S. Agency for International Development's | |
| Event A, Organization F, Organization G and | |
| Government of Country A committed to expand | |
| a maternal health emergency transportation | |
| system that is securing hospital transit for | |
| thousands of women in Country A. | |

The first machine learning model 206 of the ensemble unit 202 may be a bidirectional long short memory (BILSTM) based supervised classifier and is trained to learn a representation of the text passed and further classify the learnt representation into corresponding or specific category. The BILSTM portion of the supervised classifier consists of an input layer, a softmax layer, a forward LSTM layer, a backward LSTM layer. The first machine learning model 206 classifies the learned representations into corresponding or specific category by converting one or more words of the training dataset in input layer to corresponding/specific embedded representations. The forward LSTM layer creates a forward representation of the training dataset while reading from a first direction to a second direction (for example, say from left to right). The backward LSTM layer creates a backward representation of the training dataset while reading from the second direction to the first direction (for example, say from right to left). The forward representations are concatenated with the backward representations and the concatenated representations are passed to the hidden layer for dimensionality reduction. The output of the hidden layer is passed to the softmax layer to classify the training dataset into at least one category among the set of categories.

Referring now to the steps of the method 300, at step 304, the one or more hardware processors 104 finetune using the training dataset to train a second machine learning model wherein the trained second ML model is configured to classify at least one unlabeled news snippet of unknown category based on a premise-hypothesis pair, causing the second trained machine learning model to be agnostic (or independent of) to the first trained machine learning model.

The second machine learning model 210 of the ensemble unit 202 includes a pre-trained language model (PLM) based zero-shot natural language inference (NLI). Text classification using NLI requires the text to be classified as a premise for the NLI task. If the premise (the input text) is paired with an appropriate hypothesis, the NLI task evaluates the premise according to whether the hypothesis logically follows from the premise (consequence), contradicts (contradiction), or is irrelevant (neutral). Hypotheses are windows that allow categorical information to be incorporated into the premise-hypothesis pairs, and thus hypothesis design becomes an important part of the exercise. It is important to include categorical information in hypothesis in the most appropriate way so that PLM yields the desired predictions. A premise-hypothesis pair consists of a zero-shot natural language inference (NLI) hypothesis template and one or more of his sentences in the news snippet that indicate the category.

For example, “News snippets talks about [category word]”. Given the input text “European Aeronautic Defense and Space (EADS) agreed to acquire Racal Instruments Group”, the premise-hypothesis pair can be read as a whole (P: EADS agreed to acquire Racal Instruments Group, H: This news snippet talks about [category-designating phrases]. The [category-designating phrases] part can be replaced with phrases that best describe the category and its various aspects, if not limited to just the category name.

As another example, one or more category-indicating phrases (Table 2) such as “alliances, partnerships and relationships” may be used for the category “customers and partners.” So, an instantiation of the general premise hypothesis would be (P: EADS has agreed to acquire the Racal Instruments Group. H: This message talks about alliances, partnerships, and connections). In this way, the entire premise-hypothesis pair is instantiated for each category and the expression denoting that category. Each category and corresponding category indicating phrases are shown in Table 2.

TABLE 2
Category indicating phrases

| Category indicating phrases | Category |
|---|---|
| achievements and awards; awards and | Achievements & Recognition |
| recognitions | |
| alliances, partnerships, and tie ups; | Customers & Partners |
| companies signing deals | |
| branding and marketing; corporate | Human Resources, Branding |
| social responsibility; human resources; | and Corporate Social |
| hiring, layoffs | Responsibility |
| opening of a new office; opening of a | Business Expansion |
| new division; organizational | |
| restructuring; change of management | |
| legal cases; judicial procedures; legal | Legal |
| battles; arbitration; courts and | |
| judgements | |
| product launches | Product Launches/Offerings |
| research and development; new | Research & Innovation |
| innovations; research papers; cutting- | |
| edge technologies | |
| mergers and acquisitions; takeovers; | Mergers & Acquisitions |
| stakes and bids stake buyouts | |
| revenues; quarter results; financial | Financial Reporting |
| performance; share prices and stocks; | |
| buybacks | |
| analyst reports about companies; | Analyst Reports/Studies |
| surveys and findings | |

In the zero-shot setting, the pre-trained PLM for the NLI task is fed to each of these instantiated premise-hypothesis pairs, and the PLM determines whether there is any implication, contradiction, or neutrality between them. The premise hypothesis instance for which PLM predicts the entailment with the highest confidence is selected, and the corresponding category of the hypothesis expression indicating the category is predicted for the premise or the input text.

By using the zero-shot method, the PLM is unaware to the true semantics of the set of categories in the classification issue at hand. This illustrates how the PLM only bases its choices on prior independent pre-training when analyzing the input text and categorization terms. Consideration is given to such a classification problem, and the PLM is adjusted in a way that enables it to take into account the training data for the current issue and modify one or more weights appropriately without losing prior knowledge from pre-training. This fixes the issue and broadens PLM's expertise to enable more precise category classification (used in zero-shot settings). The same data that was utilized for the BILSTM training and is used in the fine-tuning procedure. For instance, the “gold” category of news snippets generates a pair of positive premises and hypotheses, marks them as implications, and adds them to the training dataset. When a case is considered negative, the premise-hypothesis pair links the snippet to the other categories and marks it as inconsistent. The system 100 chooses a sample from the entire collection of these negative mismatched cases and adds it to the training data set because there are typically a lot of wrong categories of snippets.

Referring now to the steps of the method 300, at step 306, the one or more hardware processors 104 generate an ensemble of machine learning models by using the first machine learning model and the second machine learning model to classify a set of test news snippets received as input request into corresponding or specific category. For example, the input request comprising the set of test news snippets to be classified into corresponding category are provided to the ensemble of machine learning models that includes the first machine learning model and the second machine learning model.

In one embodiment, categorization of news snippets as shown in Table 3 that illustrates a pseudo code is used as an example to facilitate explanation, although this is not restricted to it and can also extend to other scenarios of categorization of text data. The ensemble of machine learning models provides an ensemble result that classifies the set of test news snippets based on one or more phrases corresponding to the category from the set of categories by creating an ensemble function (referring now to Table 3 that illustrates the pseudo code). The ensemble function is created based on the set of test news snippets, the premise-hypothesis pair from the second machine learning model, a first prediction and a second prediction derived from the first machine learning model. The first prediction of the first machine learning model comprises a first closest category to which each test news snippet maps and a first prediction confidence of the first closest category. The second prediction of the first machine learning model comprises a second closest category to which each test news snippet maps and a second prediction confidence of the second closest category. Further, the first machine learning model classifies the set of test news snippets into corresponding category if the first prediction confidence is greater than or equal to a threshold.

TABLE 3
A pseudo code for training of ensemble
of machine learning models

```
Function newstype ensemble (t, bc1,p_{bc1}^{b},bc2,p_{bc2}^{b}, h [c1, r1]);
Input news snippet t,
Top 2 BiLSTM predictions with confidence (bc1,p_{bc1}^{b}), (bc2,p_{bc2}^{b}),
NLI Hypothesis template h and
Class-indicating phrases [cᵢ , rᵢ ], i ∈ set of classes C
final_newstype_predictions := [ ];
  /* check 1 : High confidence BiLSTM predictions */
If p_{bc1}^{b} ≥ 0.9 then
    final_newstype_predictions. add (bc1)
else
      /* obtain NLI predictions for bc1 and bc2 */
      p_{bc1}^{z} = fine_tuned_nli (t,h,[ c_{bc1}, r_{bc1}])
    p_{bc2}^{z} = fine_tuned_nli (t,h,[ c_{bc2}, r_{bc2}])
    /* check 2: strong threshold */
If p_{bc1}^{b} + p_{bc1}^{z} ≥ 1.5 then
      final_newstype_predictions. add (bc1)
else if p_{bc2}^{b} + p_{bc2}^{z} ≥ 1.5 then
      final_newstype_predictions. add (bc2)
/* check 3 : Weak threshold */
  Else if p_{bc1}^{b} + p_{bc1}^{z} ≥ 1 and p_{bc1}^{b} + p_{bc1}^{z} > p_{bc2}^{b} + p_{bc2}^{z} and
  (p_{bc1}^{z} ≥ 0.4 or p_{bc2}^{z} ≥ 0.4) then
    final_newstype_predictions. add (bc2)
/* check 4 : Check all classes using NLI */
Else
  /* Obtain NLI predictions for all classes */
pᵢ^{z} = fine_{tuned}_{ₙₗᵢ} (t, h, [ c_{bc1}, r_{bc1}]), ∀i ∈ C
(zc1, p_{z}^{z}c1+=max(pᵢ^{z})
        final_newstype_predictions. add (zc1)
end
end
```

In addition, if the first prediction confidence is greater than or equal to a threshold, the first machine learning model 206 places the collection of test news snippets into the appropriate category. The threshold, for instance, can be smaller than one. Additionally, one or more NLI predictions are computed using the second machine learning model to categories the set of test news snippets if the first prediction confidence is not in agreement with the threshold. Additionally, depending on one or more NLI predictions from the second machine learning model 210, each unlabeled test news snippet of an unknown category is reclassified into the appropriate/specific category.

In one embodiment, by fine-tuning the training dataset of the second machine learning model 210 and the premise-hypothesis pair, the second machine learning model 210 of the system 100 computes at least one NLI prediction over the collection of test news snippets. Additionally, a first NLI prediction confidence for the first closest category and a second NLI prediction confidence for the second closest category are obtained by the system 100 of the second machine learning model 210.

Moreover, a first combined prediction confidence is produced by adding the first prediction confidence with the first NLI prediction confidence. Combining the second NLI prediction confidence with the second prediction confidence results in the second combined prediction confidence. Based on the maximum value of the first combined prediction confidence and his second combined prediction confidence, each unlabeled test message snippet of unknown category is assigned to a corresponding specific category from a collection of categories.

In one embodiment, the training datasets comprises of two datasets-a proprietary news snippets dataset (PND) and a subset of the AG News dataset (AG). Here, a total of 1710 snippets are labeled as part of the PND dataset for category in a multi-label setting. It is noted that more than one category may be relevant to each training news snippet (referring to fourth example in Table 1) and hence, the multi-label annotation. The PND dataset is divided into five folds, each with a train subset of about 360 news snippets and test subset of 340 news snippets. Further, the training dataset are used to train the BILSTM and fine-tune the NLI PLM and evaluate using the corresponding test sets. In the original AG dataset, there is annotation only into major topical news classes namely-Business, World, Politics and Sports, but no annotation for non-topical classes. Further, a subset of 368 Business news snippets is selected and annotated for the 10 categories. Further, three annotators are employed in the process and a fourth annotator to resolve confusing cases. The AG dataset yielded high inter-annotator agreement of over 85%. Also, the AG dataset is used as an independent test dataset only and inference is done using the PND-trained model.

In one embodiment, the baseline experiments consists of (i) standard ML classifiers, namely Naive Bayes and Support Vector Machines, (ii) sentence bidirectional encoder representations from transformers (SentBERT) based cosine similarity-based classifiers, (iii) BILSTM classifiers, and (iv) Zero-shot NLI-based text classification. Naïve Bayes (NB) and Support Vector Machine (SVM) baselines are standard ML classifiers trained on the PND subset and trained using the TF-IDF representation of the input text with a lemmatized vocabulary. In the SentBERT-based baseline, we first create sentences based on the class-indicating sentences in Table 2 to represent the various classes. Sentence transformer is then used to obtain a representation of both the input text and the sentences denoting these categories. The category that matches the specification sentence representation with the highest cosine similarity to the input text representation is selected as the final prediction.

The NLI PLM is experimented with the BART based Natural Language Inference PLM namely the bart-large-mnli2. The techniques are generic and easily portable to other NLI models such as roberta-large-mnli3.

Table 4 shows the baseline and results of the method of the present disclosure (average of ≥5x PND data set) with moderate accuracy. If the prediction is in one of the instance's gold categorie(s), it is marked as correct. Mild is based on this subset-based test. Acceptable accuracy is therefore the total number of such subset corrections across test instances.

TABLE 4
Comparative Results

| Approach | PND | AG |
|---|---|---|
| NB | 0.5845 | 0.3179 |
| SVM | 0.8269 | 0.4429 |
| SentBERT | 0.5961 | 0.5598 |
| Only BiLSTM | 0.8212 | 0.5842 |
| Only ZS NLI model | 0.6986 | 0.6196 |
| Ensemble (ZS NLI + BILSTM) - | 0.8547 | 0.6712 |
| method of the present disclosure | | |

The ensemble of BILSTM and the zero-shot-based NLI are promising approaches, outperforming both the standard baseline (standard ML classifier and SentBERT) and the constituent individual approaches (BILSTM only and zero-shot NLI only). This is also true for the AG dataset, which is used only as an independent test dataset when training his BILSTM model and ensemble thresholds on the PND dataset. This demonstrated the true portability of the ensemble and classification semantics as implemented by the method of the present disclosure. Fine-tuning of the NLI model PLM improved performance compared to that of the zero-shot NLI-based ensemble on both datasets.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments of present disclosure herein address unresolved problem of text categorization. The embodiment, thus provides method and system to classify news snippets into categories using an ensemble of machine learning models. Moreover, the embodiments herein further provide automatically categorized news snippets. The ensemble is between a BiLSTM-based text classification network and a pretrained language model (PLM) based natural language inference (NLI) which is robust and accurate for such categorization.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g., any kind of computer like a server or a personal computer, or the like, or any combination thereof. The device may also include means which could be e.g., hardware means like e.g., an application-specific integrated circuit (ASIC), a field-programmable gate array (FPGA), or a combination of hardware and software means, e.g., an ASIC and an FPGA, or at least one microprocessor and at least one memory with software processing components located therein. Thus, the means can include both hardware means, and software means. The method embodiments described herein could be implemented in hardware and software. The device may also include software means. Alternatively, the embodiments may be implemented on different hardware devices, e.g., using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor implemented method to classify news snippets into categories using an ensemble of machine learning models, the method comprising:
training via one or more hardware processor a first machine learning model from a set of machine learning models using a training dataset to learn text representations and classify the learned representations into corresponding category from a set of categories;
finetuning via the one or more hardware processors using the training dataset to train a second machine learning model to classify at least one unlabeled news snippet of unknown category based on a premise-hypothesis pair, causing the second trained machine learning model to be agnostic to the first trained machine learning model; and
generating via the one or more hardware processors an ensemble of machine learning models by using the first machine learning model and the second machine learning model to classify a set of test news snippets received as input request to corresponding category.

2. The processor implemented method as claimed in claim 1, wherein the training dataset includes a set of training news snippets, and each of the training news snippet corresponds to a category from the set of categories.

3. The processor implemented method as claimed in claim 1, wherein the first machine learning model includes a bidirectional long short memory (BiLSTM) based supervised classification.

4. The processor implemented method as claimed in claim 1, wherein the second machine learning model includes a pre-trained language model (PLM) based zero-shot natural language inference (NLI).

5. The processor implemented method as claimed in claim 1, wherein the premise-hypothesis pair consists of a hypothesis template of the zero-shot natural language inference (NLI) and one or more phrases of news snippet indicative of category.

6. The processor implemented method as claimed in claim 1, wherein the ensemble of machine learning models classifies the set of test news snippets into corresponding category by,
creating an ensemble function using the set of test news snippets, the premise-hypothesis pair from the second machine learning model, a first prediction and a second prediction derived from the first machine learning model,
wherein the first prediction of the first machine learning model comprises a first closest category to which each test news snippet maps and a first prediction confidence of the first closest category,
wherein the second prediction of the first machine learning model comprises a second closest category to which each test news snippet maps and a second prediction confidence of the second closest category;
classifying the set of test news snippets using the first machine learning model if the first prediction confidence is greater than or equal to a threshold, otherwise compute one or more NLI predictions using the second machine learning model to classify the set of test news snippets into corresponding category; and
reclassify each unlabeled test news snippet of unknown category into corresponding category based on the one or more NLI predictions of the second machine learning model.

7. The processor implemented method as claimed in claim 6, wherein the second machine learning model performs at least one NLI prediction over the set of test news snippets by,
finetuning using the training dataset of the second machine learning model and the premise-hypothesis pair to obtain a first NLI prediction confidence of the first closest category and a second NLI prediction confidence of the second closest category;
obtaining a first combined prediction confidence by combining the first NLI prediction confidence with the first prediction confidence;
obtaining a second combined prediction confidence by combining the second NLI prediction confidence with the second prediction confidence; and
classifying each unlabeled test news snippet of unknown category into corresponding category from the set of categories based on highest value of the first combined prediction confidence and the second combined prediction confidence.

8. The processor implemented method as claimed in claim 1, further comprising:
providing an input request comprising a set of test news snippets to be classified into corresponding category to the ensemble of machine learning models that includes the first machine learning model and the second machine learning model; and
receiving from the ensemble of machine learning models, an ensemble result that classifies the set of test news snippets based on one or more phrases corresponding to the category from the set of categories.

9. A system 100 to classify news snippets into categories using an ensemble of machine learning models comprising:
a memory storing instructions;
one or more communication interfaces; and
one or more hardware processors coupled to the memory via the one or more communication interfaces, wherein the one or more hardware processors are configured by the instructions to:
train a first machine learning model from a set of machine learning models using a training dataset to learn text representations and classify the learned representations into corresponding category from a set of categories;
finetune using the training dataset to train a second machine learning model to classify at least one unlabeled news snippet of unknown category based on a premise-hypothesis pair, causing the second trained machine learning model to be agnostic to the first trained machine learning model; and
generate an ensemble of machine learning models by using the first machine learning model and the second machine learning model to classify a set of test news snippets received as input request to corresponding category.

10. The system as claimed in claim 9, wherein the training dataset includes a set of training news snippets, and each of the training news snippet corresponds to a category from the set of categories.

11. The system as claimed in claim 9, wherein the first machine learning model includes a bidirectional long short memory (BILSTM) based supervised classification.

12. The system as claimed in claim 9, wherein the second machine learning model includes a pre-trained language model (PLM) based zero-shot natural language inference (NLI).

13. The system as claimed in claim 9, wherein the premise-hypothesis pair consists of a hypothesis template of the zero-shot natural language inference (NLI) and one or more phrases of news snippet indicative of category.

14. The system as claimed in claim 9, wherein the ensemble of machine learning models classifies the set of test news snippets into corresponding category by,
creating an ensemble function using the set of test news snippets, the premise-hypothesis pair from the second machine learning model, a first prediction and a second prediction derived from the first machine learning model,
wherein the first prediction of the first machine learning model comprises a first closest category to which each test news snippet maps and a first prediction confidence of the first closest category,
wherein the second prediction of the first machine learning model comprises a second closest category to which each test news snippet maps and a second prediction confidence of the second closest category;
classifying the set of test news snippets using the first machine learning model if the first prediction confidence is greater than or equal to a threshold, otherwise compute one or more NLI predictions using the second machine learning model to classify the set of test news snippets into corresponding category; and
reclassify each unlabeled test news snippet of unknown category into corresponding category based on the one or more NLI predictions of the second machine learning model.

15. The system as claimed in claim 14, wherein the second machine learning model performs at least one NLI prediction over the set of test news snippets by,
finetuning using the training dataset of the second machine learning model and the premise-hypothesis pair to obtain a first NLI prediction confidence of the first closest category and a second NLI prediction confidence of the second closest category;
obtaining a first combined prediction confidence by combining the first NLI prediction confidence with the first prediction confidence;
obtaining a second combined prediction confidence by combining the second NLI prediction confidence with the second prediction confidence; and
classifying each unlabeled test news snippet of unknown category into corresponding category from the set of categories based on highest value of the first combined prediction confidence and the second combined prediction confidence.

16. The system as claimed in claim 11, wherein the one or more hardware processors are further configured by the instructions to:
provide an input request comprising a set of test news snippets to be classified into corresponding category to the ensemble of machine learning models that includes the first machine learning model and the second machine learning model; and
receive from the ensemble of machine learning models, an ensemble result that classifies the set of test news snippets based on one or more phrases corresponding to the category from the set of categories.

17. One or more non-transitory machine-readable information storage mediums comprising one or more instructions which when executed by one or more hardware processors cause:
training a first machine learning model from a set of machine learning models using a training dataset to learn text representations and classify the learned representations into corresponding category from a set of categories;
finetuning using the training dataset to train a second machine learning model to classify at least one unlabeled news snippet of unknown category based on a premise-hypothesis pair, causing the second trained machine learning model to be agnostic to the first trained machine learning model; and
generating an ensemble of machine learning models by using the first machine learning model and the second machine learning model to classify a set of test news snippets received as input request to corresponding category.

18. The one or more non-transitory machine-readable information storage mediums of claim 17, wherein the training dataset includes a set of training news snippets, and each of the training news snippet corresponds to a category from the set of categories.

19. The one or more non-transitory machine-readable information storage mediums of claim 17, wherein the first machine learning model includes a bidirectional long short memory (BILSTM) based supervised classification.

20. The one or more non-transitory machine-readable information storage mediums of claim 17, wherein the second machine learning model includes a pre-trained language model (PLM) based zero-shot natural language inference (NLI).
